(19) United States
(12) Patent Application Publication
(10) Pub. No.: US 2024/0163602 A1
(43) Pub. Date: May 16, 2024

(54) PANEL AUDIO LOUDSPEAKERS INCLUDING MECHANICALLY GROUNDED MAGNETIC CIRCUIT

(71) Applicant: Google LLC, Mountain View, CA (US)

(72) Inventors: Andrew Phillis, Campbell, CA (US); Timothy A. Gladwin, Mountain View, CA (US); Rajiv Bernard Gomes, San Jose, CA (US); Anthony King, San Jose, CA (US); Jason David Walker, Mountain View, CA (US); Neil John Harris, Los Altos, CA (US)

(21) Appl. No.: 18/280,061

(22) PCT Filed: Jun. 24, 2022
(86) PCT No.: PCT/US2022/034975

§ 371 Date: Sep. 1, 2023

Related U.S. Application Data
(60) Provisional application No. 63/215,316, filed on Jun. 25, 2021.

(51) Int. Cl. H04R 1/28; H04R 1/02; H04R 7/04; H04R 9/02; H04R 9/04; H04R 9/06

(52) U.S. Cl. CPC H04R 1/2873; H04R 1/025; H04R 1/028; H04R 7/04; H04R 9/025; H04R 9/045; H04R 9/06; H04R 2400/11; H04R 2499/11; H04R 2499/15

(57) ABSTRACT

A device includes: a panel and an electromagnetic actuator mechanically coupled to a rear side of the panel to form a panel audio loudspeaker, the electromagnetic actuator comprising a coil attached to the rear side of the panel and a magnet suspended with respect to the coil via one or more spring elements, the coil defining an axis, wherein during operation of the device an electric current through the coil varies a relative displacement of the magnet with respect to the coil along the axis. The device includes: a chassis supporting the panel, the chassis comprising a housing for the device, the housing comprising a rear panel on an opposite side of the device from the panel; and a grounding assembly positioned along the axis between the magnet and the rear panel of the device, wherein the grounding assembly mechanically grounds the magnet to the chassis.

### CROSS-REFERENCE TO RELATED APPLICATIONS

This application claims the benefit of priority to U.S. Application No. 63/215,316, filed on Jun. 25, 2021, the contents of which are hereby incorporated by reference.

### BACKGROUND

This specification relates to panel audio loudspeakers that include a mechanically grounded magnetic circuit.

Many conventional loudspeakers produce sound by inducing piston-like motion in a diaphragm. Panel audio loudspeakers, in contrast, operate by inducing distributed vibration modes in a panel through an electro-acoustic actuator. Typically, the actuators are electromagnetic or piezoelectric actuators.

When inertially driven panel audio loudspeakers are integrated into an electronic device such as a mobile phone, the loudspeakers may cause excessive vibration. These vibrations can negatively affect end user experience, co-existing technologies within the system, and external environments, such as when the device is placed on a table.

### SUMMARY

Disclosed are devices including panel audio loudspeakers featuring an actuator attached to an acoustic radiator such as a panel (e.g., a display panel). The device includes a grounding assembly between the actuator and a chassis of the device. The grounding assembly can reduce unwanted vibrations of the device. The shape, material, and relative position of the grounding assembly can be selected to accommodate size constraints of the device. In addition, the grounding assembly can be configured to reduce vibration of the device without degrading sound output of the panel audio loudspeaker. For example, the shape, material, and/or relative position of the elements composing the grounding assembly can result in reducing undesirable vibrations without degrading the sound.

In general, in a first aspect, the disclosed implementations feature a device including: a panel; an electromagnetic actuator mechanically coupled to a rear side of the panel to form a panel audio loudspeaker, the electromagnetic actuator including a coil attached to the rear side of the panel and a magnet suspended with respect to the coil via one or more spring elements, the coil defining an axis. During operation of the device an electric current through the coil varies a relative displacement of the magnet with respect to the coil along the axis. The device includes a chassis supporting the panel, the chassis including a housing for the device, the housing including a rear panel on an opposite side of the device from the panel; and a grounding assembly positioned along the axis between the magnet and the rear panel of the device. The grounding assembly mechanically grounds the magnet to the chassis.

In some implementations, the grounding assembly includes a compliant element.

In some implementations, the compliant element is selected from the group consisting of: a piece of foam, a piece of rubber, a piece of silicone, a three-dimensional polymer structure, a spring, a pressure sensitive adhesive.

In some implementations, the grounding assembly includes more than one compliant element.

In some implementations, a first side of the compliant element contacts the magnet.

In some implementations, a second side of the compliant element opposite the first side contacts the chassis.

In some implementations, the device further includes one or more additional components within the housing, the one or more additional components being rigidly coupled to the chassis.

In some implementations, the electromagnetic actuator includes a hood covering the magnet and the coil.

In some implementations, the grounding assembly extends through an opening in the hood.

In some implementations, the grounding assembly includes a first grounding element contacting a roof of the hood external to the hood, and electromagnetic actuator includes a second grounding element between the magnet and the roof of the hood.

In some implementations, the panel is an OLED display panel or a microLED display panel.

In some implementations, the panel includes a flat panel display extending in a plane, and the axis defined by the coil is normal to the plane.

In some implementations, the device is a mobile phone or a tablet computer.

In general, in another aspect, the disclosed implementations feature a panel audio loudspeaker including: a display panel; an electromagnetic actuator mechanically coupled to a rear side of the display panel, the electromagnetic actuator including: a coil attached to the rear side of the display panel; and a magnet suspended with respect to the coil via one or more spring elements, the coil defining an axis. During operation of the panel audio loudspeaker, an electric current through the coil varies a relative displacement of the magnet with respect to the coil along the axis; and a mechanical grounding assembly attached to the magnet and positioned along the axis.

In some implementations, the mechanical grounding assembly includes a compliant element.

In some implementations, the compliant element is selected from the group consisting of: a piece of foam, a piece of rubber, a piece of silicone, a three-dimensional polymer structure, a spring, a pressure sensitive adhesive.

In some implementations, the mechanical grounding assembly is configured to be positioned between the panel audio loudspeaker and a chassis supporting the display panel.

In some implementations, the chassis includes a rear panel on an opposite side of the chassis from the display panel, the mechanical grounding assembly being configured to be positioned between the magnet and the rear panel.

In some implementations, the electromagnetic actuator includes a hood covering the magnet and the coil.

In some implementations, the mechanical grounding assembly extends through an opening in the hood.

In some implementations, the mechanical grounding assembly includes a first grounding element contacting a roof of the hood external to the hood, and the electromagnetic actuator includes a second grounding element between the magnet and the roof of the hood.

In some implementations, the display panel is an OLED display panel or a microLED display panel.

In some implementations, the display panel includes a flat panel display extending in a plane, and the axis defined by the coil is normal to the plane.

Advantages of the disclosed techniques can include mitigating device vibration while maintaining sound output of a panel audio loudspeaker. Vibration mitigation in devices can often result in reducing the sound pressure level output by a loudspeaker. The disclosed techniques can reduce vibration without degrading performance of the loudspeaker, and/or while reducing any degradation in performance of the loudspeaker. Other advantages will be evident from the description, drawings, and claims.

### BRIEF DESCRIPTION OF THE DRAWINGS

FIG. 1 is a perspective view of an embodiment of a mobile device that includes a panel audio loudspeaker.

FIG. 2 is a schematic cross-sectional view of the mobile device of FIG. 1.

FIG. 3 shows a schematic cross-sectional view of a portion of a mobile device showing an example actuator grounded to a chassis of the device by a grounding assembly.

FIG. 4 is a cross-sectional diagram of a portion of a mobile device showing an example actuator grounded to a chassis of the device by a grounding assembly.

FIGS. 5A and 5B are a cross-sectional view and a perspective sectional view, respectively, of an example mobile device including an actuator and a grounding assembly.

FIG. 6A is a sectional perspective view of a portion of a mobile device including an actuator and a grounding assembly.

FIGS. 6B and 6C are perspective views of the actuator and grounding assembly shown in FIG. 6A.

FIGS. 7A and 7B are perspective views of the actuator shown in FIG. 6A with another example of a grounding assembly.

FIGS. 8A and 8B are perspective views of the actuator shown in FIG. 6A with yet another example of a grounding assembly.

FIG. 9 is a plot that shows sound pressure level versus frequency for a panel audio loudspeaker without a grounding assembly and for a panel audio loudspeaker with a grounding assembly.

FIG. 10 is a plot that shows displacement of an actuator magnet versus frequency of the actuator for a panel audio loudspeaker without a grounding assembly and for a panel audio loudspeaker with a grounding assembly.

FIGS. 11A-11C are plots showing displacement versus frequency for various example embodiments of actuators with grounding assemblies.

FIG. 12 is a schematic diagram of an embodiment of an electronic control module for a mobile device.

Like reference symbols in the various drawings indicate like elements.

### DETAILED DESCRIPTION

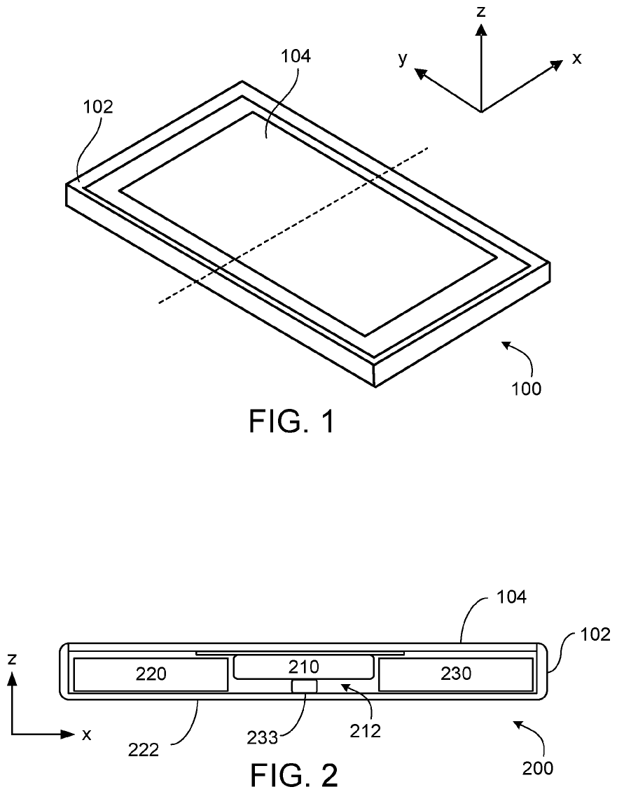

The disclosure features actuators for panel audio loudspeakers, such as distributed mode loudspeakers (DMLs). Such loudspeakers can be integrated into a mobile device, such as a mobile phone or a tablet computer. For example, referring to FIG. 1, a mobile device 100 includes a device chassis 102 and a touch panel display 104, or simply panel 104. The chassis 102 supports the panel 104. The chassis 102 has a greater length than the panel 104 in the y-direction, and a greater width than the panel 104 in the x-direction.

The panel 104 can be, for example, an OLED, microLED, or LCD display panel that is part of a panel audio loudspeaker. The panel 104 can be a flat panel or a curved panel. Mobile device 100 interfaces with a user in a variety of ways, including by displaying images and receiving touch input via panel 104. Typically, a mobile device that is a mobile phone has a depth (in the z-direction) of approximately 10 mm or less, a width (in the x-direction) of 60 mm to 80 mm (e.g., 68 mm to 72 mm), and a height (in the y-direction) of 100 mm to 160 mm (e.g., 138 mm to 144 mm). Tablet computers can be larger but generally have a similar rectangular shape.

Mobile device 100 also produces audio output. The audio output is generated using the panel audio loudspeaker that creates sound by causing the panel to vibrate. The panel is mechanically coupled to an actuator, such as a moving magnet actuator. The actuator is a movable component arranged to provide a force to a panel, such as panel 104, causing the panel to vibrate. The vibrating panel generates human-audible sound waves, e.g., in the range of 20 Hz to 20 kHz. Generally, the efficiency of the actuator to produce audible sound waves varies as a function of frequency depending on the properties of the actuator, the panel, and the coupling of the actuator to the panel. Typically, the actuator/panel system will exhibit one or more resonant frequencies representing frequencies at which the sound pressure level as a function of frequency has a local maximum. It is generally desirable, however, for a panel audio loudspeaker to maintain a relatively high sound pressure level across the entire audio frequency spectrum.

In addition to producing sound output, mobile device 100 can also produce haptic output using the actuator. For example, the haptic output can correspond to vibrations in the range of 180 Hz to 300 Hz.

FIG. 1 also shows a dashed line that corresponds to the cross-sectional direction shown in FIG. 2. Referring to FIG. 2, a cross-section 200 of mobile device 100 illustrates device chassis 102. The chassis 102 provides a structural frame supporting panel 104 and functions as an external housing for the device 100. FIG. 2 also includes a Cartesian coordinate system with x, y, and z axes, for ease of reference. Device chassis 102 has a depth measured along the z-direction and a width measured along the x-direction. The width of the chassis 102 is wider than the width of the panel 104 in the x-direction. The chassis 102 encloses components of the device 100 including an actuator 210, an electronic control module 220, and a battery 230.

Device chassis 102 includes a rear panel 222, which is formed by the portion of device chassis 102 that extends primarily parallel to the panel 104 in the xy-plane. Mobile device 100 includes the actuator 210, which is housed in a space defined by panel 104 and the rear panel 222 of chassis 102. More specifically, actuator 210 is positioned behind panel 104 within chassis 102 and affixed to the back side of the panel 104. Generally, actuator 210 is sized to fit within a volume constrained by other components enclosed within chassis 102, including the electronic control module 220 and the battery 230.

The device 100 includes an amount of free space 212 between the actuator 210 and the rear panel 222. The free space 212 enables the actuator to vibrate in the z-direction without contacting the rear panel 222. The actuator 210 can be grounded to the rear panel 222 by a mechanical grounding assembly 233. The grounding assembly 233 occupies a portion of the free space 212 between the actuator 210 and the rear panel 222. The grounding assembly 233 is positioned between the actuator 210 and the rear panel 222 in the z-direction.

The chassis 102 is formed from a rigid or semi-rigid material. The chassis 102 provides a foundation to enable mechanical grounding of actuator 210. In some implementations, the chassis 102 can be structurally reinforced to increase the rigidity of the chassis 102. For example, the chassis 102 can be reinforced at or near a location where the grounding assembly 233 couples to the rear panel 222. The rigidity of the chassis 102 can be enhanced using one or more reinforcement elements, e.g., stiffeners or ribs.

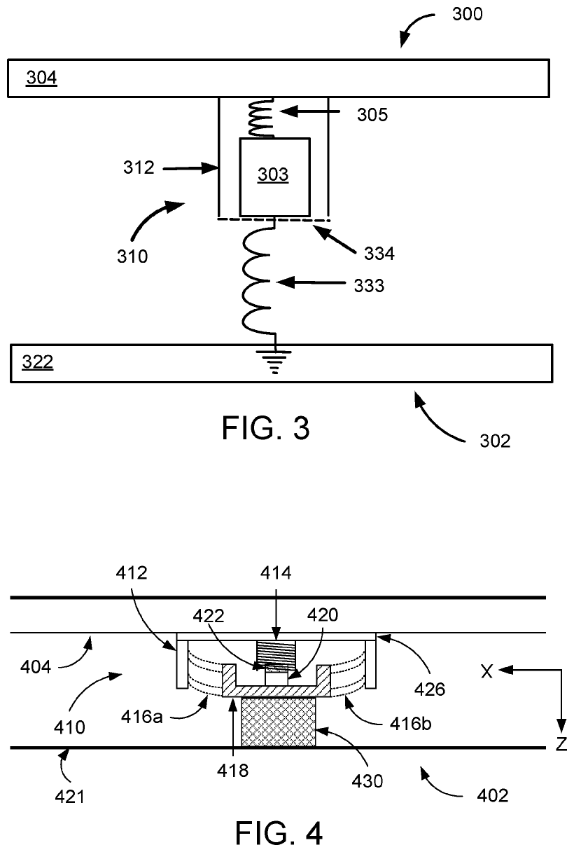

FIG. 3 shows a schematic cross-sectional view of a portion of a device 300 showing an actuator 310 grounded to the chassis 302 of the device 300 by a grounding assembly 333. The grounding assembly 333 is positioned between a magnet 303 of the actuator and a rear panel 322 of a chassis 302. The rear panel 322 is on an opposite side of the device from a display panel 304, to which the actuator 310 is attached.

In some examples, the device includes additional components and structures within the housing. The additional components can be rigidly coupled to the chassis. In some examples, the grounding assembly 333 can mechanically ground the magnet 303 to the chassis via one or more of the additional components. For example, the grounding assembly 333 can contact the magnet 303 on a first side, and can contact one of the additional components on a second side that is opposite the first side. By mechanically grounding the magnet 303 to the chassis, the grounding assembly can inhibit relative motion and dissipate energy so as to reduce the transfer of vibration between the magnet 303 and the chassis.

The electromagnetic actuator 310 is attached to a rear side of the display panel 304 to form a panel audio loudspeaker. The actuator 310 includes a frame 312 that is affixed to the panel 304, e.g., by an adhesive or other rigid bond. The magnet 303 is mechanically coupled to the panel 304 by spring assembly 305, which suspends the magnet 303 from the frame 312. The panel 304 can be, for example, a flat panel display or a curved panel display.

In some examples, the actuator 310 can include a hood that covers the magnet 303 and spring assembly 305. In some examples, the grounding assembly 333 can extend through an opening in the hood. Alternatively, or additionally, the grounding assembly 333 can include components on either side of the hood to mechanically ground the magnet 303 to the chassis 302. In some examples, the grounding assembly 333 can include a first grounding element that contacts a roof 334 of the hood that is external to the hood. A second grounding element can then be positioned between the magnet 303 and the roof 334 of the hood.

FIG. 4 is a cross-sectional diagram of a portion of a mobile device showing an actuator 410 grounded to a chassis 402 by a grounding assembly 430. Referring to FIG. 4, electromagnetic actuator 410 includes a magnet assembly 418 suspended from a frame 412 by flexible members 416a/b relative to a coil 414 that is attached to a base plate 426 bonded to the rear surface of a panel 404. The coil 414 defines an axis normal to the plane of the panel 404 (parallel to the z-axis shown in the figure). In some examples, the panel 404 is a flat panel that extends in a plane. In some examples, the display panel 404 is a curved panel and the coil 414 is attached to the panel 404 at an attachment point, the coil 414 defining an axis that is perpendicular to the plane of the panel 404 at the attachment point.

The grounding assembly 430 includes one or more grounding elements. The grounding elements can be formed from compliant or non-compliant material. The grounding assembly is positioned between the magnet assembly 418 and a rear panel 421 of the chassis 402. Specifically, the grounding assembly 430 is positioned along the axis between the magnet assembly 418 and the rear panel 421. The grounding assembly can be mechanically coupled to the magnet assembly 418, to the rear panel 421, or both. The grounding assembly mechanically grounds the magnet assembly 418 to the rear panel 421 of the chassis 402.

It will be appreciated that reference to the grounding assembly being positioned “along the axis” is not intended to require that the grounding assembly is positioned so that it is strictly aligned with the axis, or even on the axis. Rather, the grounding assembly 430 may extend away from the magnet assembly 418 in a direction generally parallel to the axis towards the rear panel 421. The frame 412 includes side walls that extend primarily in the z-direction perpendicular to the base plate 426 and the pair of flexible members 416a and 416b that suspend the magnet assembly 418 over coil 414. The flexible members 416a and 416 allow relative movement between the magnet assembly 418 and the magnetic coil 414. The magnetic coil 414 is attached to the rear side of the display panel 404 via base plate 426.

The magnet assembly 418, or motor assembly, includes a spacer 420 and a pole magnet 422 (a permanent magnet) attached to the spacer. The magnet assembly 418 also includes a magnetic cup, which can be composed of one or more additional magnets. Pole magnet 422 can be circular in the xy-plane and generate a radial magnetic field perpendicular to the z-axis. Magnet assembly 418, spacer 420, and pole magnet 422 are shaped so that there is an air gap between the walls of the magnetic cup and the pole magnet. This air gap accommodates magnetic coil 414 and provides space for relative motion between the coil 414 and magnet assembly 418.

During the operation of the actuator 410, electronic control module 220 (shown in FIG. 2) energizes magnetic coil 414, such that an electric current passes through the coil. The current induces a magnetic field perpendicular to the magnetic field of pole magnet 422. Typically, the direction of the magnetic field to be in the x-direction so that the field is perpendicular to the flow of current. A magnetic field that surrounds coil 414 is induced by the current. Coil 414 experiences a force exerted by the magnetic field of the magnet assembly as a result of the placement of coil 414 in the magnetic field. The electric current through the coil varies a relative displacement of the magnet with respect to the coil 414 along the axis. As a result of the induced magnetic field, the magnet assembly is displaced in the z-direction. Alternating the direction of the current causes the magnet assembly to vibrate back and forth in the z-direction relative to the coil 414 exerting a force on panel 404, which also vibrates in the z-direction generating sound waves.

Although shown in FIGS. 3 and 4 as a moving magnet actuator, the disclosed techniques can be applied to other actuator motor structures. For example, in some embodiments a magnet may be affixed to the panel 404 and a coil can be suspended with respect to the magnet. In some embodiments, instead of a coil and a magnet, two coils may be used, e.g., a voice coil and a field coil.

The grounding assembly 430 mechanically grounds magnet assembly 418 to the rear panel 421. In some examples, the grounding assembly 430 includes a grounding element composed of a single piece of compliant material that contacts the magnet assembly 418 on one side, and contacts the chassis on an opposite side.

In general, grounding assemblies such as grounding assembly 430 are composed of one or more grounding elements. The grounding elements can be formed from a material having mechanical properties suitable for grounding the magnet to the chassis. Generally, grounding elements can be formed from any material or combination of materials that have mechanical properties sufficient to reduce vibration of the chassis while maintaining desired sound levels output by the panel audio loudspeaker. A grounding element can be, for example, a compliant element formed from a metal, a plastic, a rubber, a foam, an elastomer, a polyurethane, a thermoplastic elastomer, a three-dimensional polymer structure, a three-dimensional energy-absorbent polymer structure, a three-dimensional printed structure; a piece of silicone, a spring, a pressure sensitive adhesive. In some examples, the compliant element can include any combination of these materials.

In some embodiments, the compliant element can be formed from a material having a Shore A hardness in a range from 20 to 90 (e.g., 25 or more, 30 or more, 35 or more, 40 or more, 45 or more, e.g., 85 or less, 80 or less, 75 or less, 70 or less, 65 or less). In addition, the compliant element should be sufficiently resilient so that it does not deform or fatigue as a result of its interaction with the other components of the actuator. The compliant element should be sufficiently resilient so that it does not deform or fatigue as a result of operating temperatures within the device. In some cases, the compliant element can be, for example, a spring (e.g., a helical spring, a leaf spring, a compression spring, a wave spring, or a conical spring).

In some embodiments, a grounding assembly can include one or more elements formed from a non-compliant or rigid material. For example, a grounding assembly can include grounding elements formed from a material such as plastic having a Shore D hardness in a range from 20 to 90 (e.g., 25 or more, 30 or more, 35 or more, 40 or more, 45 or more, e.g., 85 or less, 80 or less, 75 or less, 70 or less, 65 or less). In some examples, the grounding assembly can include grounding elements formed from a material such as metal having a Young's modulus of 50 gigapascals (GPa) or more (e.g., 75 GPa or more, 100 GPa or more, 150 GPa or more, 200 GPa or more). The grounding assembly can rigidly connect the magnet assembly to the chassis.

Compliant elements can be formed from a material or combination of materials based on thermal properties of the material(s). For example, the compliant element(s) can be formed from any material or combination of materials that provide the desired mechanical properties (i.e., to reduce vibration of the device due to the actuator) across the range of temperatures the grounding assembly is exposed to during operation of the device. For example, the compliant element can be formed from a material or combination of materials that can withstand temperatures as low as, e.g., −40° C., −30° C., −20° C., etc. The compliant element can be formed from a material or combination of materials that can also withstand temperatures as high as, e.g., 80° C., 85° C., 90° C., etc. The material can be selected at least in part based on stability of the material and consistency of material performance at temperature wells below and well above room temperature. An example material can maintain stability and consistency across a temperature range from, e.g., −40° C. to 90° C., −20° C. to 80° C., −40° C. to 125° C., 0° C. to 70° C., or −55° C. to 125° C.

In some embodiments, compliant elements can be formed from a material or combination of materials based on thermal conductivity, electrical conductivity, or both. For example, it may be desirable to use materials that are thermally conducting or thermally insulating. In some embodiments it may be desirable to use materials that are electrically conducting or electrically insulating, or any combination of conductivity characteristics.

Generally, the size and shape of a compliant element can vary. It can be desirable to keep the compliant element as small as possible in order to avoid substantially increasing the volume required by the actuator. In some embodiments, the compliant element can be shaped to have the same footprint (i.e., shape in the xy-plane) as the magnet assembly 418 (e.g., circular). In certain cases, the compliant element can have a smaller footprint than the magnet assembly.

In some embodiments, the device can include multiple instances of identical grounding assemblies. For example, the device can include a first grounding assembly and a second grounding assembly that each includes a compression spring. In some embodiments, the device can include multiple instances of dissimilar grounding assemblies. The dissimilar grounding assemblies can be chosen to have characteristics that are complementary in nature (e.g., elements that have different performance characteristics at different temperature and/or frequency ranges. For example, the device can include a first grounding assembly that includes a compression spring and a second grounding assembly that includes a three-dimensional polymer structure. The multiple instances can, for example, be arranged radially and/or symmetrically about the axis of the magnet assembly, or they could be arranged concentrically from the axis of the magnet assembly.

In some cases, a grounding assembly can have a surface area less than the surface area of the magnet assembly, at the location where the grounding assembly couples to the magnet assembly (e.g., on the back plate of a magnetic cup). A surface area of the grounding assembly can be, for example, three quarters of the surface area of the magnet assembly or less, half of the surface area of the magnet assembly or less, a third of the surface area of the magnet assembly or less, a quarter of the surface area of the magnet assembly or less, etc. In an example embodiment, the magnet assembly has a back surface attached to a grounding assembly including a compliant element, the back surface having a surface area of approximately one hundred square millimeters, and the compliant element having a surface area of approximately thirty square millimeters.

In general, the size, shape, and material properties of the grounding assembly are chosen based on desired sound output and vibrational requirements of the system. For example, in some embodiments, the grounding assembly is selected to provide a reduced vibration of the chassis at a range of frequencies, e.g., frequencies less than 1 kHz. The addition of a grounding assembly, e.g., including a compliant element, can maintain sound output levels while reducing unwanted vibration of the chassis, compared to panel audio loudspeakers without a grounding assembly. For example, the grounding assembly can reduce vibration by a factor of approximately fifty at frequencies less than 300 Hz, by a factor of approximately twenty at frequencies between 300 Hz and 500 Hz, and by a factor of approximately five at frequencies between 500 Hz and 800 Hz, relative to panel audio loudspeakers without the grounding assembly. The composition, size, and shape of compliant element(s) composing the grounding assembly can be established empirically, using computer simulations, or both.

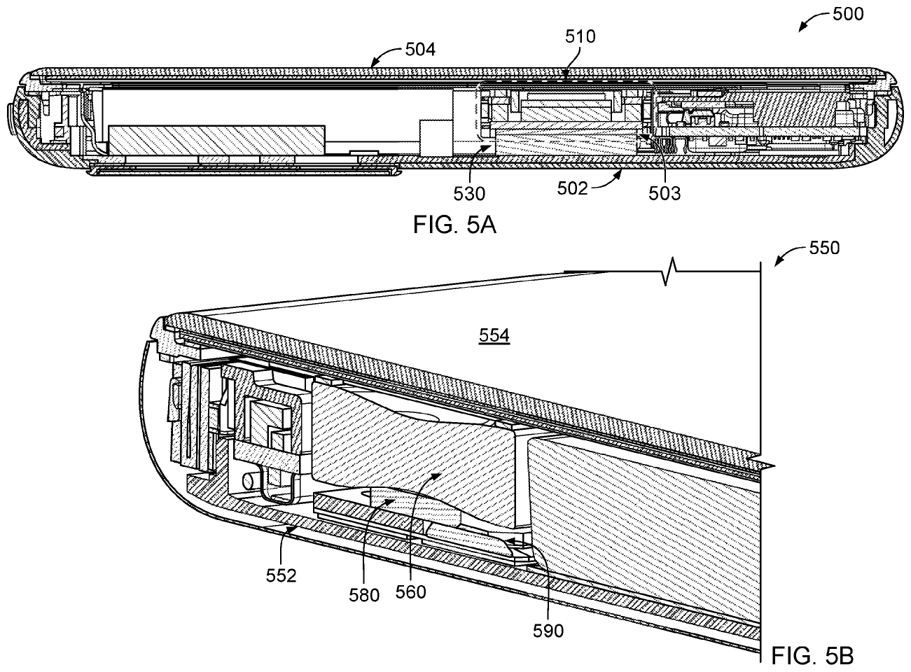

FIGS. 5A and 5B are cross-sectional views of mobile devices including an actuator and a grounding assembly. FIG. 5A shows a cross-sectional view of mobile device 500 including actuator 510, display panel 504, and rear panel 502. The actuator 510 is mechanically grounded to the rear panel 502 by grounding assembly 530. The grounding assembly 530 can include a compliant element such as a compressed foam. The mobile device 500 also includes adhesive 503 which bonds the actuator 510 to the compliant element of the grounding assembly 530. In this example, the compliant element is coextensive with the magnet assembly of the actuator 510.

FIG. 5B shows a perspective cross-sectional view of a mobile device 550 including an actuator 560, a display panel 554, and a rear panel 552 which is part of the device's chassis. The mobile device 550 also includes additional components 590 (e.g., microchips, printed circuit board, battery) that are rigidly coupled to the rear panel 552. The actuator 560 is mechanically grounded to the rear panel 552 by grounding assembly 580 via the additional components 590. The grounding assembly 580 contacts the actuator 560 on a first side, and one or more of the additional component 590 on a second side opposite the first side.

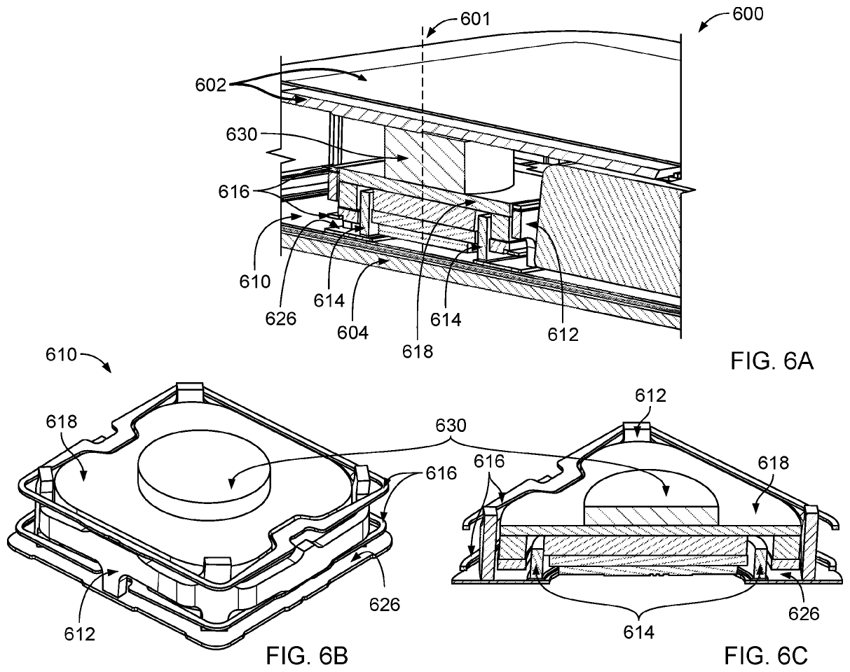

FIG. 6A shows a perspective sectional view of yet a further a mobile device 600 that includes an actuator 610 with a grounding assembly composed of a coupling element 630 mechanically grounding a magnet assembly 618 of the actuator with the chassis 602 of the device. The actuator 610 further includes a coil 614 that is attached to a base plate 626. The base plate 626 is, itself, attached to the back surface of a panel 604, which is the load for the actuator. Flexible members (e.g., leaf springs) 616 suspend the magnet assembly 618 from a frame 612 relative to the coil 614. The coil 614 defines an axis 601 that is perpendicular to the plane of the panel 604 and the plane of a back panel of chassis 602. In some examples, the panel 604 is a flat panel that extends in a plane. In some examples, the panel 604 is a curved panel and the coil 614 is attached to the panel 604 at an attachment point, the coil 614 defining an axis 601 that is perpendicular to a plane of the panel 604 at the attachment point. The frame 612 is attached to the base plate 626.

FIGS. 6B and 6C show perspective views of the actuator 610 showing the coupling element 630 which is a circular block of compliant material (e.g., foam. pressure sensitive adhesive) positioned centrally on the back plate of the base of magnet assembly 618. The back plate of the magnet assembly 618 has a larger, square footprint with rounded corners that has a larger diameter than the circular footprint of the coupling element 630.

While the grounding assembly shown in FIGS. 6A-6C is composed of a single block of compliant material, an alternative arrangement is to use multiple blocks of compliant material, e.g., four blocks each positioned at a corner of the square magnet assembly base plate.

In such an arrangement, it will again be understood that reference to the grounding assembly being positioned “along the axis” is not intended to require that any part of the grounding assembly is positioned so that it is on the axis. Rather, the blocks of compliant material cooperate to provide a grounding assembly that extends away from the magnet assembly in a direction generally parallel to the axis towards the back panel of the chassis.

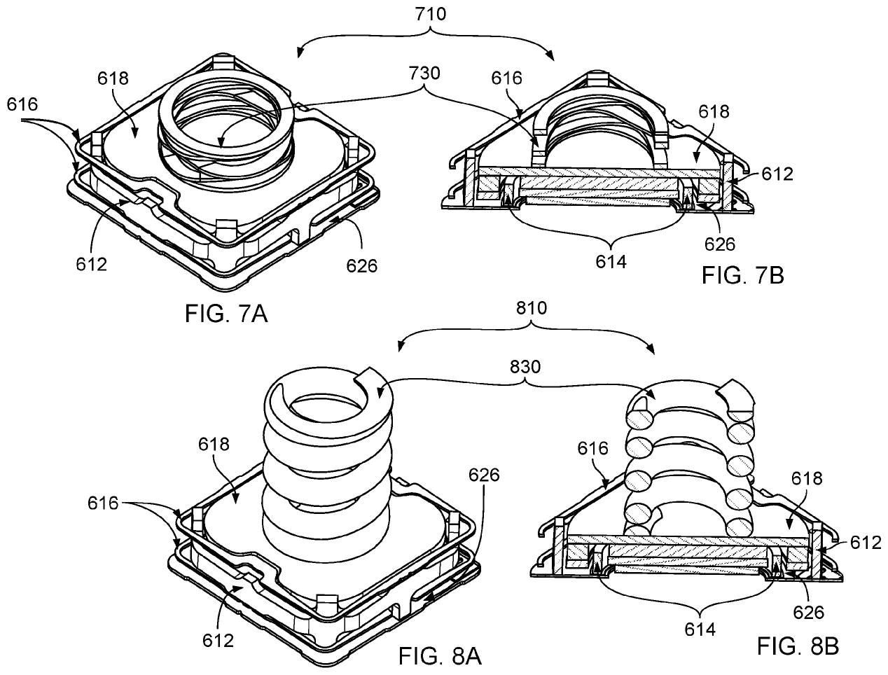

As noted above, in some cases, a grounding assembly can include a coupling element that is a spring. Examples of two different such grounding elements are illustrated in FIGS. 7A-8B. In particular, FIGS. 7A and 7B show actuator 710 with a grounding assembly composed of a wave spring 730 arranged on the back plate of magnet assembly 618. The wave spring 730 is arranged so that the spring's axis is substantially aligned with the axis 601 of coil 614.

FIGS. 8A and 8B show actuator 810 with a grounding assembly composed of a compression spring 830 arranged on the back plate of magnet assembly 618. The compression spring 830 is arranged so that the spring's axis is substantially aligned with the axis 601 of coil 614.

While both of the foregoing embodiments feature a single spring, other implementations are possible. For instance, ground assemblies can be composed of more than one spring (e.g., two, three, four or more). In some embodiments, a grounding assembly is composed of four springs, one at each corner of the magnet assembly 618.

Generally, the stiffness of the spring constant can vary depending on a desired response of the system. In some embodiments, a spring with a spring constant of at least 5 N/mm is used (e.g., 10 N/mm or more, 20 N/mm or more, 30 N/mm or more, 50 N/mm or more, 75 N/mm or more, 100 N/mm or more, such as up to 300 N/mm or less, 250 N/mm or less, 200 N/mm or less, 150 N/mm or less).

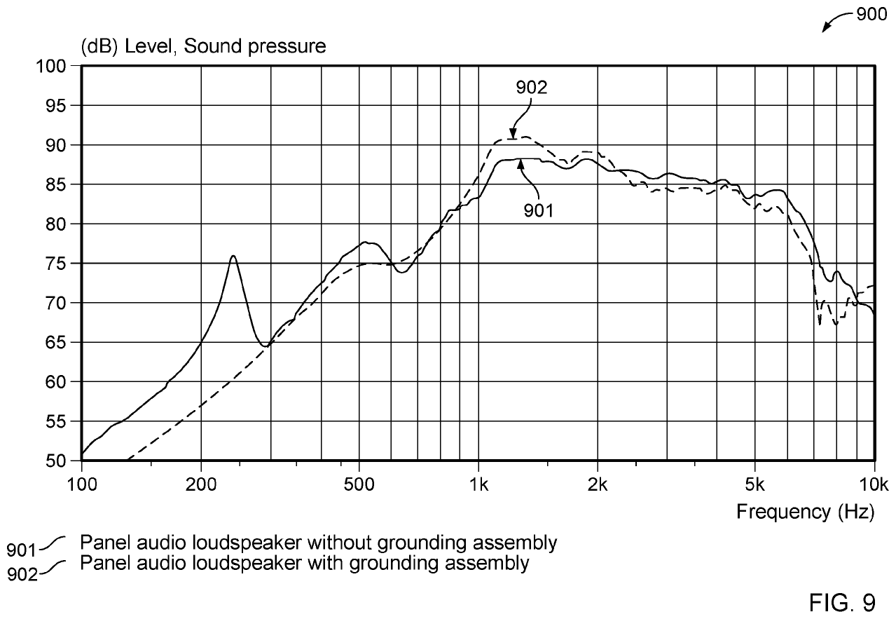

Turning now to an example of the effect of a grounding assembly on the frequency response of a panel audio loudspeaker, FIG. 9 shows an experimentally generated plot 900 of sound pressure level, measured in dB, versus frequency, measured in Hz, for two panel audio loudspeakers. The frequency response is shown for a frequency range from 100 Hz to 10 kHz. A first curve 901 corresponds to the frequency response of a panel audio loudspeaker featuring a control actuator that does not include a grounding assembly, referred to as an inertial response below. This curve shows a resonance peak at 240 Hz, corresponding to the drive frequency for the actuator. A second curve 902 corresponds to the frequency response of a panel audio loudspeaker featuring an actuator that includes a grounding assembly positioned between a magnet and a rear panel, as described with regard to FIGS. 3 and 4.

Plot 900 shows that the actuator represented by curve 902 can provide a similar output to the actuator represented by curve 901 over a wide range of frequencies (e.g., from 300 Hz to 5 kHz). Plot 900 also shows certain frequencies at which the actuator provides a slightly greater output than the inertial actuator. Specifically, for frequencies from approximately 750 Hz to just above 2 kHz, the panel audio loudspeaker featuring the grounding assembly outputs a sound pressure level that is slightly greater than the panel audio loudspeaker featuring the control actuator.

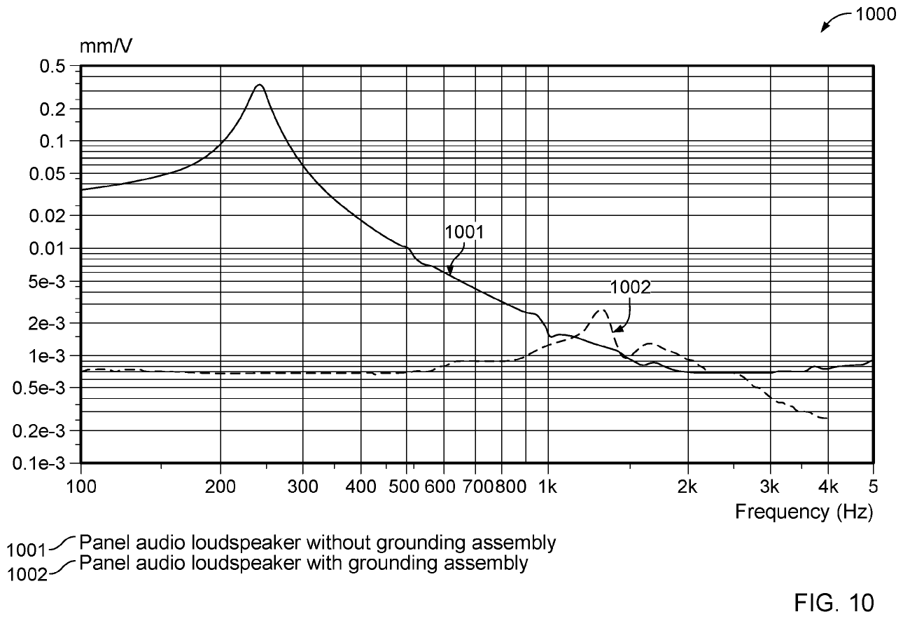

As discussed above, the material properties of the grounding assembly, e.g., including a compliant element, contribute to the reduction of vibration of the chassis. This can be evidenced by measuring a displacement of the magnet assembly relative to the chassis over a frequency range for low and mid-range audible frequencies. For example, FIG. 10 shows an experimentally generated plot 1000 of vibrational displacement of a magnet assembly in a panel audio loudspeaker, measured in mm/V, versus the frequency of the panel audio loudspeaker, measured in Hz. The plot 1000 shows a laser-measured displacement of the magnet assembly during operation over the range from 100 Hz to 5 kHz. Plot 1000 shows two curves. Curve 1001 corresponds to panel audio loudspeaker without a grounding assembly between the actuator and the rear panel, referred to as an “inertial” case. Curve 1002 corresponds to a panel audio loudspeaker with a grounding assembly between the actuator, e.g., actuator 310, and the rear panel, e.g., rear panel 421. In this example, the grounding assembly is a wave spring with a coating that includes a flexible adhesive material. The coating can fill gaps between turns of the wave spring and increase stiffness of the wave spring.

Plot 1000 shows that the panel audio loudspeaker with the grounding assembly has a substantially reduced vibrational displacement compared to the panel audio loudspeaker without the grounding assembly, in particular at frequencies less than 1 kHz. Displacement plots for several examples follow.

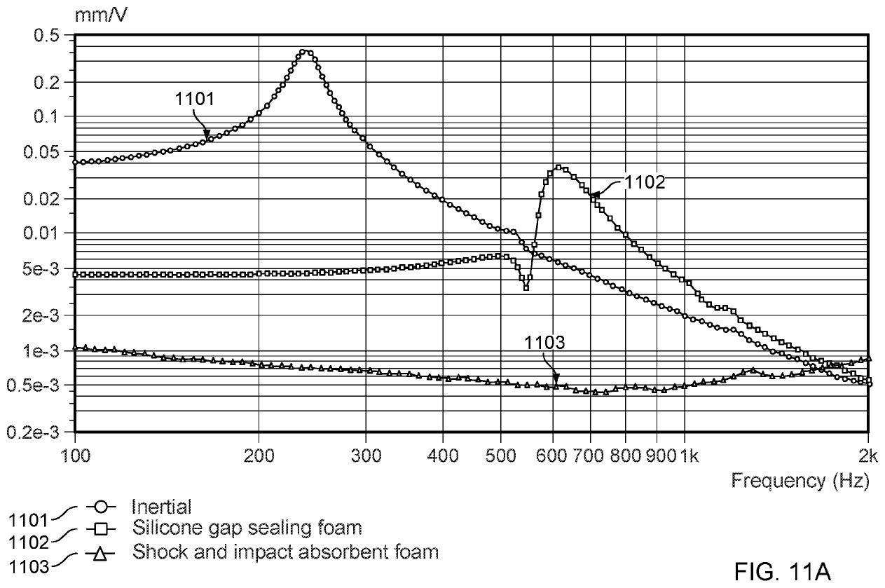

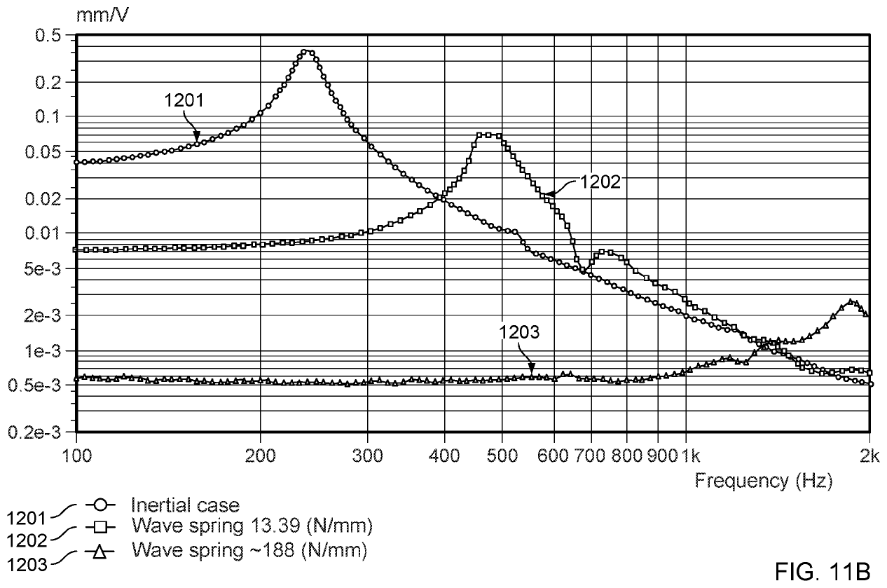

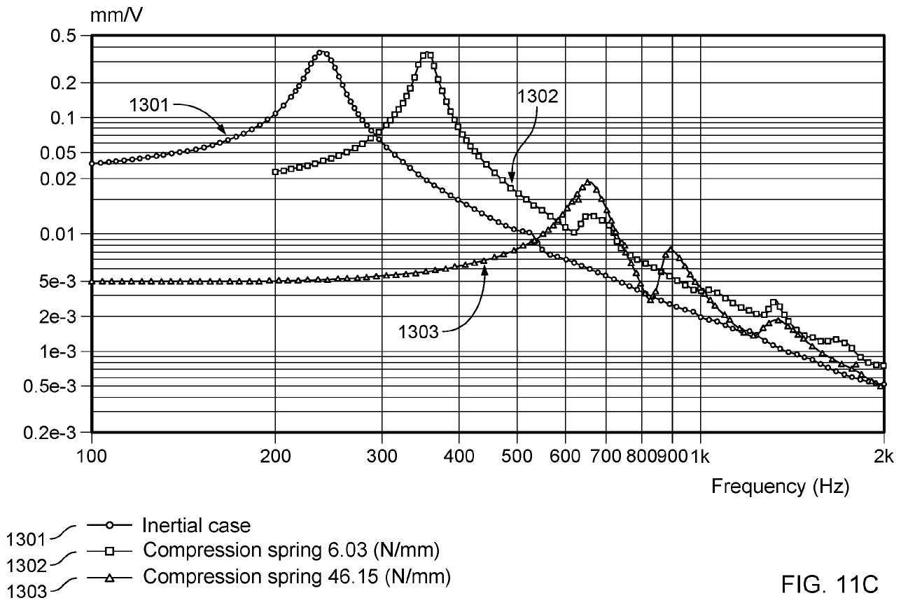

FIG. 11A shows a plot comparing displacement of an actuator with a grounding assembly composed of a silicone gap sealing foam (curve 1102) and a grounding assembly composed of a shock and impact absorbent foam (curve 1103) with the inertial case (curve 1101). Displacement is shown from 100 Hz to 2 kHz.

Compared to the inertial case, at low frequencies (e.g., below 400 Hz), both foams significantly reduce displacement compared to the inertial case, although the shock and impact absorbent foam reduces displacement about five or more times more than the silicone foam over this range. Curve 1102 shows a resonant peak at approximately 600 Hz. Curve 1103 does not display a noticeable peak across the range shown.

FIG. 11B shows a plot comparing displacement of a magnet assembly in an actuator for the inertial case (1201), a grounding assembly composed of a first wave spring (1202), and another grounding assembly composed of a second wave spring (1203). The first wave spring has a spring constant of 13.39 N/mm and the second wave spring is stiffer, with a spring constant of 188 N/mm. Both springs reduce displacement of the magnet assembly, with the stiffer spring reducing it approximately 10 times more for frequencies below 400 Hz. Curve 1202 shows a resonant peak at about 500 Hz and shows displacement similar to the inertial case for frequencies above 700 Hz.

FIG. 11C shows another plot comparing displacement of the inertial case (1301), with an actuator with a grounding assembly composed of a first compression spring (1302) and a further grounding assembly composed of a second compression spring (1303). Displacement is shown across a frequency range from 100 Hz to 2 kHz. The first compression spring has a spring constant of 6.03 N/mm. Maximum displacement of the magnet assembly in this case does not dramatically change compared to the inertial case, although the resonance peak is shifted from 240 Hz to about 350 Hz. The second compression spring has a spring constant of 46.15 N/mm and dramatically reduces displacement of the magnet assembly compared to the inertial case. For example, peak displacement is reduced by a factor of more than 10 and the resonance peak is shifted from 240 Hz to about 650 Hz.

As noted previously, in general, the composition, shape, size, and type of the components of the grounding assembly can be determined empirically and/or by simulation. The grounding assembly can be designed to so that the SPL is reduced by no more than 25 dB (e.g., 20 dB or less, 18 dB or less, 15 dB or less, 12 dB or less, 10 dB or less) at any single frequency in a range from about 100 Hz to about 1 kHz (e.g., from 100 Hz to 750 Hz, from 100 Hz to 600 Hz, from 100 Hz to 500 Hz, from 100 Hz to 400 Hz, from 100 Hz to 300 Hz) compared to an inertial arrangement composed of the same actuator, chassis, and load without the grounding assembly. In some embodiments, a displacement of a magnet assembly of the actuator is reduced by at least a factor of three compared to an inertial arrangement composed of the same actuator, chassis, and load without the grounding assembly. Displacement of the chassis can decrease in relationship with displacement of the magnet assembly, e.g., proportionally with displacement of the magnet assembly. Thus, reduction of displacement of the magnet assembly can reduce vibration of the chassis during actuator operation.

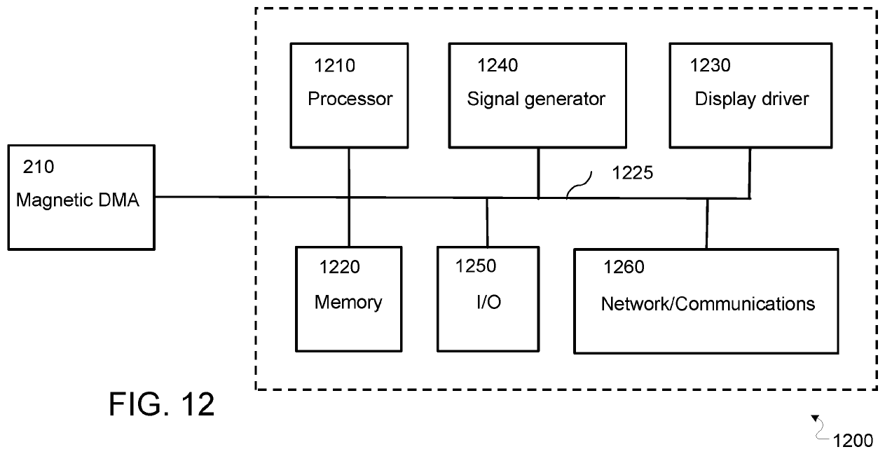

In general, the disclosed actuators are controlled by an electronic control module, e.g., electronic control module 220 in FIG. 2 above. In general, electronic control modules are composed of one or more electronic components that receive input from one or more sensors and/or signal receivers of the mobile phone, process the input, and generate and deliver signal waveforms that cause actuator 210 to provide a suitable haptic response. Referring to FIG. 12, an exemplary electronic control module 1200 of a mobile device, such as mobile device 100, includes a processor 1210, memory 1220, a display driver 1230, a signal generator 1240, an input/output (I/O) module 1250, and a network/communications module 1260. These components are in electrical communication with one another (e.g., via a signal bus 1225) and with actuator 210.

Processor 1210 may be implemented as any electronic device capable of processing, receiving, or transmitting data or instructions. For example, processor 1210 can be a microprocessor, a central processing unit (CPU), an application-specific integrated circuit (ASIC), a digital signal processor (DSP), or combinations of such devices.

Memory 1220 has various instructions, computer programs or other data stored thereon. The instructions or computer programs may be configured to perform one or more of the operations or functions described with respect to the mobile device. For example, the instructions may be configured to control or coordinate the operation of the device's display via display driver 1230, signal generator 1240, one or more components of I/O module 1250, one or more communication channels accessible via network/communications module 1260, one or more sensors (e.g., biometric sensors, temperature sensors, accelerometers, optical sensors, barometric sensors, moisture sensors and so on), and/or actuator 210.

Signal generator 1240 is configured to produce AC waveforms of varying amplitudes, frequency, and/or pulse profiles suitable for actuator 210 and producing acoustic and/or haptic responses via the actuator. Although depicted as a separate component, in some embodiments, signal generator 1240 can be part of processor 1210. In some embodiments, signal generator 1240 can include an amplifier, e.g., as an integral or separate component thereof.

Memory 1220 can store electronic data that can be used by the mobile device. For example, memory 1220 can store electrical data or content such as, for example, audio and video files, documents and applications, device settings and user preferences, timing and control signals or data for the various modules, data structures or databases, and so on. Memory 1220 may also store instructions for recreating the various types of waveforms that may be used by signal generator 1240 to generate signals for actuator 210. Memory 1220 may be any type of memory such as, for example, random access memory, read-only memory, Flash memory, removable memory, or other types of storage elements, or combinations of such devices.

As briefly discussed above, electronic control module 1200 may include various input and output components represented in FIG. 12 as I/O module 1250. Although the components of I/O module 1250 are represented as a single item in FIG. 12, the mobile device may include a number of different input components, including buttons, microphones, switches, and dials for accepting user input. In some embodiments, the components of I/O module 1250 may include one or more touch sensors and/or force sensors. For example, the mobile device's display may include one or more touch sensors and/or one or more force sensors that enable a user to provide input to the mobile device.

Each of the components of I/O module 1250 may include specialized circuitry for generating signals or data. In some cases, the components may produce or provide feedback for application-specific input that corresponds to a prompt or user interface object presented on the display.

As noted above, network/communications module 1260 includes one or more communication channels. These communication channels can include one or more wireless interfaces that provide communications between processor 1210 and an external device or other electronic device. In general, the communication channels may be configured to transmit and receive data and/or signals that may be interpreted by instructions executed on processor 1210. In some cases, the external device is part of an external communication network that is configured to exchange data with other devices. Generally, the wireless interface may include, without limitation, radio frequency, optical, acoustic, and/or magnetic signals and may be configured to operate over a wireless interface or protocol. Example wireless interfaces include radio frequency cellular interfaces, fiber optic interfaces, acoustic interfaces, Bluetooth interfaces, Near Field Communication interfaces, infrared interfaces, USB interfaces, Wi-Fi interfaces, TCP/IP interfaces, network communications interfaces, or any conventional communication interfaces.

In some implementations, one or more of the communication channels of network/communications module 1260 may include a wireless communication channel between the mobile device and another device, such as another mobile phone, tablet, computer, or the like. In some cases, output, audio output, haptic output or visual display elements may be transmitted directly to the other device for output. For example, an audible alert or visual warning may be transmitted from the mobile device 100 to a mobile phone for output on that device and vice versa. Similarly, the network/communications module 1260 may be configured to receive input provided on another device to control the mobile device. For example, an audible alert, visual notification, or haptic alert (or instructions therefor) may be transmitted from the external device to the mobile device for presentation.

The actuator technology disclosed herein can be used in panel audio systems, e.g., designed to provide acoustic and/or haptic feedback. The panel may be a display system, for example based on OLED, microLED, or LCD technology. The panel may be part of a smartphone, tablet computer, or wearable devices (e.g., smartwatch or head-mounted device, such as smart glasses).

Other embodiments are in the following claims.

1. A device, comprising:
a panel;
an electromagnetic actuator mechanically coupled to a rear side of the panel to form a panel audio loudspeaker, the electromagnetic actuator comprising a coil attached to the rear side of the panel and a magnet suspended with respect to the coil via one or more spring elements, the coil defining an axis, wherein during operation of the device an electric current through the coil varies a relative displacement of the magnet with respect to the coil along the axis;
a chassis supporting the panel, the chassis comprising a housing for the device, the housing comprising a rear panel on an opposite side of the device from the panel; and
a grounding assembly positioned along the axis between the magnet and the rear panel of the device,
wherein the grounding assembly mechanically grounds the magnet to the chassis.

2. The device of claim 1, wherein the grounding assembly comprises a compliant element.

3. The device of claim 2, wherein the compliant element is selected from the group consisting of: a piece of foam, a piece of rubber, a piece of silicone, a three-dimensional polymer structure, a spring, a pressure sensitive adhesive.

4. The device of claim 2, wherein the grounding assembly comprises more than one compliant element.

5. The device of claim 2, wherein a first side of the compliant element contacts the magnet and a second side of the compliant element opposite the first side contacts the chassis.

6. (canceled)

7. The device of claim 1, further comprising one or more additional components within the housing, the one or more additional components being rigidly coupled to the chassis.

8. The device of claim 1, wherein the electromagnetic actuator comprises a hood covering the magnet and the coil.

9. The device of claim 8, wherein the grounding assembly extends through an opening in the hood.

10. The device of claim 8, wherein the grounding assembly comprises a first grounding element contacting a roof of the hood external to the hood, and the electromagnetic actuator comprises a second grounding element between the magnet and the roof of the hood.

11. The device of claim 1, wherein the panel comprises an OLED display panel or a microLED display panel and the device is a mobile phone or a tablet computer.

12. The device of claim 1, wherein the panel comprises a flat panel display extending in a plane, and the axis defined by the coil is normal to the plane.

13. (canceled)

14. A panel audio loudspeaker comprising:
a display panel;
an electromagnetic actuator mechanically coupled to a rear side of the display panel, the electromagnetic actuator comprising:
a coil attached to the rear side of the display panel; and
a magnet suspended with respect to the coil via one or more spring elements, the coil defining an axis, wherein during operation of the panel audio loudspeaker an electric current through the coil varies a relative displacement of the magnet with respect to the coil along the axis; and
a mechanical grounding assembly attached to the magnet and positioned along the axis.

15. The panel audio loudspeaker of claim 14, wherein the mechanical grounding assembly comprises a compliant element selected from the group consisting of: a piece of foam, a piece of rubber, a piece of silicone, a three-dimensional polymer structure, a spring, a pressure sensitive adhesive.

16. (canceled)

17. The panel audio loudspeaker of claim 14, wherein the mechanical grounding assembly is configured to be positioned between the panel audio loudspeaker and a chassis supporting the display panel.

18. The panel audio loudspeaker of claim 17, wherein the chassis comprises a rear panel on an opposite side of the chassis from the display panel, the mechanical grounding assembly being configured to be positioned between the magnet and the rear panel.

19. The panel audio loudspeaker of claim 14, wherein the electromagnetic actuator comprises a hood covering the magnet and the coil.

20. The panel audio loudspeaker of claim 19, wherein the mechanical grounding assembly extends through an opening in the hood.

21. The panel audio loudspeaker of claim 19, wherein the mechanical grounding assembly comprises a first grounding element contacting a roof of the hood external to the hood, and the electromagnetic actuator comprises a second grounding element between the magnet and the roof of the hood.

22. The panel audio loudspeaker of claim 14, wherein the display panel comprises an OLED display panel or a microLED display panel.

23. The panel audio loudspeaker of claim 14, wherein the display panel comprises a flat panel display extending in a plane, and the axis defined by the coil is normal to the plane.
